(19) United States
(12) Patent Application Publication
(10) Pub. No.: US 2014/0127607 A1
(43) Pub. Date: May 8, 2014

(54) CATHODE FOR SOLID OXIDE FUEL CELL, METHOD OF MANUFACTURING THE SAME, AND SOLID OXIDE FUEL CELL INCLUDING THE SAME

(71) Applicant: Samsung Electronics Co., Ltd., Suwon-si (KR)

(72) Inventors: Chan KWAK, Yongin-si (KR); Doh-won JUNG, Seoul (KR); Ji-haeng YU, Daejeon (KR); Hee-jung PARK, Suwon-si (KR); Sung-jin AHN, Anyang-si (KR)

(73) Assignee: Samsung Electronics Co., Ltd., Suwon-si (KR)

(21) Appl. No.: 13/896,395

(22) Filed: May 17, 2013

(30) Foreign Application Priority Data
Nov. 2, 2012 (KR) 10-2012-0123745

(51) Int. Cl. H01M 4/90; H01M 4/88

(52) U.S. Cl. CPC H01M 4/9025; H01M 4/8828
USPC 429/482; 429/523; 429/528; 429/527; 427/115

(57) ABSTRACT

A cathode for a solid oxide fuel cell, the cathode including: a mixed ionic-electronic conductor having a structure in a form of a pattern.

### CROSS-REFERENCE TO RELATED APPLICATION

This application claims priority to and the benefit of Korean Patent Application No. 10-2012-0123745, filed on Nov. 2, 2012, and all the benefits accruing therefrom under 35 U.S.C. §119, the content of which is incorporated herein in its entirety by reference.

### BACKGROUND

1. Field

The present disclosure relates to a cathode for a solid oxide fuel cell, methods of manufacturing the same, and a solid oxide fuel cell including the same, and more particularly, to a cathode for a solid oxide fuel cell with improved stability, methods of manufacturing the same, and a solid oxide fuel cell including the same.

2. Description of the Related Art

A solid oxide fuel cell (“SOFC”) is a highly efficient and environmentally friendly electrochemical energy generation technology that directly converts chemical energy of a fuel gas into electric energy. An SOFC has many advantages, such as use of relatively low cost materials when compared to other types of fuel cells, having a relatively high tolerance for impurities of fuels, hybrid power generation capability, high efficiency, and the like. In addition, an SOFC may directly use a hydrocarbon-based fuel without having to reform the fuel into hydrogen, resulting in simplification and a decrease in the cost of the fuel cell system. An SOFC includes an anode, where a fuel such as hydrogen and hydrocarbon is oxidized, a cathode where an oxygen gas is reduced to provide an oxygen ion (O²⁻), and a ceramic solid electrolyte where an oxygen ion is conducted.

SOFC research and development has sought to improve the cost and durability of SOFCs. Since an SOFC is composed of ceramic materials, one of the characteristics to be obtained therefrom is thermal stability. The ceramic materials may crack depending on operating temperatures, and thus, there is a need to prevent cracking to improve the thermal stability.

### SUMMARY

Provided is a cathode for a solid oxide fuel cell (“SOFC”) having improved thermal stability.

Provided is a method of manufacturing the cathode for the SOFC.

Provided is a SOFC in which thermal stability is improved.

Additional aspects will be set forth in part in the description which follows and, in part, will be apparent from the description.

According to an aspect, a cathode for a solid oxide fuel cell (“SOFC”) includes a mixed ionic-electronic conductor having a structure in the form of a pattern.

According to another aspect, a method of manufacturing a cathode for a solid oxide fuel cell (SOFC) includes: forming a slurry composition including a mixed ionic-electronic conductor, a resin, and an organic solvent; disposing the slurry composition on a support; and heat treating the coating to manufacture the cathode.

According to another aspect, a solid oxide fuel cell (SOFC) includes the above-described cathode; an anode; and a solid electrolyte disposed between the cathode and the anode.

Also disclosed is a cathode for a solid oxide fuel cell, the cathode including: a mixed ionic-electronic conductor, wherein the mixed ionic-electronic conductor has a structure in a form of a pattern including units including the mixed ionic-electronic conductor, and an interval of about 0.1 micrometer to about 5 micrometers between adjacent units of the pattern, wherein the cathode has a resistance of less than about 0.35 ohms square centimeters when determined by complex impedance spectroscopy after a 400° C. thermal shock from 800° C. at 10° C. per minute.

### BRIEF DESCRIPTION OF THE DRAWINGS

These and/or other aspects will become apparent and more readily appreciated from the following description of the embodiments, taken in conjunction with the accompanying drawings in which:

FIG. 1 is a view schematically illustrating an embodiment of a surface of a cathode, the cathode having a structure in the form of a pattern;

FIG. 2 is a view schematically illustrating a cross section of another embodiment of a cathode having a structure in the form of a pattern;

FIG. 3 is a view schematically illustrating a cross section of an embodiment of a cathode having a structure without a pattern;

FIG. 4 is a cross-sectional view illustrating an embodiment of a half cell;

FIG. 5 is a cross-sectional view illustrating another embodiment of a half cell;

FIG. 6 is a scanning electron microscope (SEM) image showing a cathode surface of Comparative Example 1;

FIG. 7 is an SEM image showing a cathode surface of Comparative Example 1 after thermal shock;

FIG. 8 is an SEM image showing a cathode surface of Example 1;

FIG. 9 is an SEM image showing a cathode surface of Example 1 after thermal shock;

FIG. 10 is an SEM image showing a cathode interface of Comparative Example 1;

FIG. 11 is an SEM image showing a cathode interface of Comparative Example 1 after thermal shock;

FIG. 12 is an SEM image showing a cathode interface of Example 1;

FIG. 13 is an SEM image showing a cathode interface of Example 1 after thermal shock; and

FIG. 14 is a graph of reactance (Z₂, ohms·cm²) versus resistance (Z₁, ohms·cm²) showing the impedance of end cells of Example 1 and Comparative Example 1.

### DETAILED DESCRIPTION

Reference will now be made in detail to embodiments, examples of which are illustrated in the accompanying drawings, wherein like reference numerals refer to like elements throughout. In this regard, the present embodiments may have different forms and should not be construed as being limited to the descriptions set forth herein. Accordingly, the embodiments are merely described below, by referring to the figures, to explain aspects of the present description.

It will be understood that when an element is referred to as being “on” another element, it can be directly on the other element or intervening elements may be present therebetween. In contrast, when an element is referred to as being “directly on” another element, there are no intervening elements present.

It will be understood that, although the terms “first,” “second,” “third” etc. may be used herein to describe various elements, components, regions, layers, and/or sections, these elements, components, regions, layers, and/or sections should not be limited by these terms. These terms are only used to distinguish one element, component, region, layer, or section from another element, component, region, layer, or section. Thus, “a first element,” “component,” “region,” “layer,” or “section” discussed below could be termed a second element, component, region, layer, or section without departing from the teachings herein.

The terminology used herein is for the purpose of describing particular embodiments only and is not intended to be limiting. As used herein, the singular forms “a,” “an,” and “the” are intended to include the plural forms, including “at least one,” unless the content clearly indicates otherwise. “Or” means “and/or.” As used herein, the term “and/or” includes any and all combinations of one or more of the associated listed items. It will be further understood that the terms “comprises” and/or “comprising,” or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof.

Spatially relative terms, such as “beneath,” “below,” “lower,” “above,” “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the exemplary term “below” can encompass both an orientation of above and below. The device may be otherwise oriented (rotated 90 degrees or at other orientations) and the spatially relative descriptors used herein interpreted accordingly.

Unless otherwise defined, all terms (including technical and scientific terms) used herein have the same meaning as commonly understood by one of ordinary skill in the art to which this disclosure belongs. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

Exemplary embodiments are described herein with reference to cross section illustrations that are schematic illustrations of idealized embodiments. As such, variations from the shapes of the illustrations as a result, for example, of manufacturing techniques and/or tolerances, are to be expected. Thus, embodiments described herein should not be construed as limited to the particular shapes of regions as illustrated herein but are to include deviations in shapes that result, for example, from manufacturing. For example, a region illustrated or described as flat may, typically, have rough and/or nonlinear features. Moreover, sharp angles that are illustrated may be rounded. Thus, the regions illustrated in the figures are schematic in nature and their shapes are not intended to illustrate the precise shape of a region and are not intended to limit the scope of the present claims.

According to an embodiment, provided is a cathode for a solid oxide fuel cell (SOFC) including a mixed ionic-electronic conductor, i.e., a material with mixed conductivity, and having a structure in the form of a pattern.

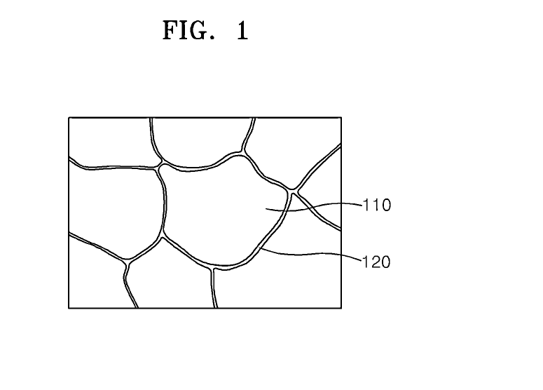

An embodiment of the structure in the form of a pattern that the cathode has is illustrated in FIG. 1. As shown, the cathode may have a pattern in which units comprising a cathode material 110, e.g., the mixed ionic-electronic conductor, are separated by an interval 120. While not wanting to be bound by theory, it is understood that the pattern exerts a buffering effect which permits the cathode to better sustain high-temperature thermal shock so that the cathode material 110 may be effectively or substantially prevented from being broken, damaged, delaminated, or otherwise degraded. In the case of the cathode without a pattern, the cathode material may expand in response to the thermal shock and contract after the thermal shock occurs, resulting in the formation of cracks and degradation of the cathode.

The units of the pattern of the cathode may have any suitable shape, and may have a repetitive form having a selected size. In an embodiment, the patterned cathode may have units having 2 or 3-dimensional structural features. The units of the patterned cathode can comprise a variety or regular or irregular geometrical features. Regular geometrical features are those that follow Euclidean geometry, in which, the mass of the feature is directly proportional to a characteristic dimension of the feature raised to an integer number. Examples of regular geometrical features are triangles, squares, spheres, hemispheres, rods, polygons. The pattern can comprise a combination comprising at least one of the foregoing geometries. Irregular geometrical features are those that follow non-Euclidean geometry, in which, the mass of the feature is directly proportional to a characteristic dimension of the feature raised to a fractional number. Examples of non-Euclidean geometries are fractals. Fractals can be surface or mass fractals. The units of the pattern of the cathode can have dimensions in the micrometer range or in the nanometer range. As defined herein when a pattern is characterized as having dimensions in the micrometer range, then at least one dimension of the pattern is less than or equal to about 1000 micrometers. An approximate form of a unit of the pattern may be circular, but is not limited thereto, and the units may have varied and complex forms.

A unit of the pattern may be defined by a closed curve. In an embodiment, each of the units of the pattern may be defined by, e.g., surrounded by, a closed curve, but not necessarily. A portion of the pattern units may be associated with a neighboring pattern. As used, herein, a “closed curve” is inclusive of any shape, e.g., curvilinear and/or rectilinear. The shape defined by the closed curve may be regular or irregular, but is generally irregular.

The term “length” as used in the present specification refers to the longest dimension of an object. For example, a length of a unit of the pattern may be defined as a major axis length of the pattern unit. An average length of a unit may be an average of the length of the major axis and a length of a minor axis.

A unit of the pattern may have a length in a range of about 10 micrometers (μm) to about 1,000 μm, specifically about 50 μm to about 700 μm, more specifically about 100 μm to about 600 μm. In an embodiment, each unit of a pattern may have a length in a range from about 10 μm to about 1,000 μm, for example, in a range of about 50 μm to about 700 μm, or in a range of about 50 μm to about 500 μm. Also, an average length of units of a pattern may be about 10 μm to about 1,000 μm, specifically about 50 μm to about 700 μm, more specifically about 100 μm to about 600 μm. In addition, a dimension of a minor axis of a pattern may be about 0.1 μm to about 1,000 μm, specifically about 0.5 μm to about 700 μm, more specifically about 1 μm to about 600 μm. Due to the increase in a size of a triple phase boundary within this range, a high-performance SOFC may be provided.

An area of a unit of the pattern may be obtained by calculation or by imaging, for example. The area of a unit may be in a range of about 10 μm² to about 10000 μm², or in a range of about 100 μm² to about 5000 μm². An average area of units of a pattern may be in a range of about 10 μm² to about 10000 μm², or in a range of about 100 μm² to about 5000 μm².

The interval 120 may be present between adjacent units of the pattern. The size of the interval 120 does not need to be kept constant in the pattern and a size of each interval 120 of a pattern may be independently selected. The size of the interval 120 of the pattern may be measured from a cross-section of the cathode, or on the surface of the cathode and in a direction of a minor dimension of the interval.

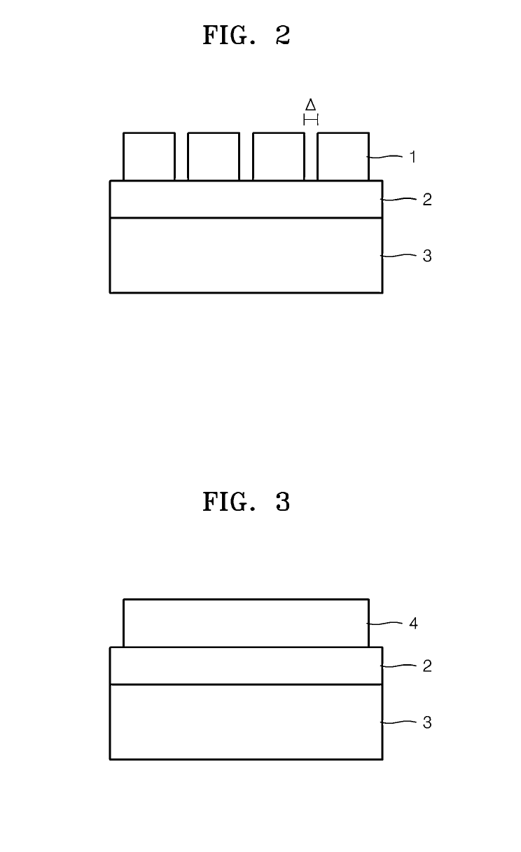

The interval of the pattern in a cross section of the cathode is schematically illustrated in FIG. 2. Pattern 1 of the cathode illustrated in FIG. 2 is present on an anode 3 and an electrolyte layer 2, and the pattern has an interval Δ. FIG. 3 shows a cathode 4 without an interval. The interval of the pattern 1 may be, for example, in a range of about 0.1 μm to about 5 μm, or about 0.1 μm to about 3 μm. While not wanting to be bound by theory, it is understood that an interval in the foregoing range may provide a sufficient buffering effect to provide a cathode with suitable thermal stability.

A thickness of the cathode having the pattern may be in a range of about 1 μm to about 100 μm, for example, in a range of about 5 μm to about 50 μm. The cathode having a thickness within this range may be suitable to act as an electrode for an SOFC.

A mixed ionic-electronic conductor used to form the cathode is a mixed ionic and electronic conductor (“MIEC”) having ionic and electronic conductivity at the same time. In addition, the MIEC has a suitably high oxygen diffusion coefficient and a suitable charge transfer rate coefficient so that an oxygen reduction reaction may be performed not only on the triple phase boundary but also on the entire surface of the fuel, and therefore, the active electrode's enhanced performance at low temperatures may contribute to lower operating temperatures of the SOFC. The mixed ionic-electronic conductor may be a perovskite-based metal oxide represented by Formula 1 below.

AMO_{3±y} Formula 1

wherein in Formula 1,

A is at least one selected from La, Ba, Sr, Sm, Gd, and Ca,

M is at least one selected from Mn, Fe, Co, Ni, Cu, Ti, Nb, Cr, and Sc, and

γ is an oxygen excess or oxygen deficiency and may be in a range of 0≦γ≦0.3.

For example, the perovskite-based metal oxide may be represented by Formula 2 below.

A′₁₋ₓA″ₓM′O_{3±y} Formula 2

wherein in Formula 2,

A′ is at least one selected from Ba, La, and Sm,

A″ is at least one selected from Sr, Ca, and Ba and is different from A′,

M′ is at least one selected from Mn, Fe, Co, Ni, Cu, Ti, Nb, Cr, and Sc and is in a range of 0 and

γ is an oxygen excess or oxygen deficiency and is in a range of 0≦γ≦0.3.

Examples of the perovskite-based metal oxide include barium strontium cobalt iron oxide (“BSCF”), lanthanum strontium cobalt oxide (“LSC”), lanthanum strontium cobalt iron oxide (“LSCF”), lanthanum strontium cobalt manganese oxide (“LSCM”), lanthanum strontium iron oxide (“LSF”), samarium strontium cobalt oxide (“SSC”), or the like.

In detail, the perovskite-based metal oxide may be Ba₁₋ₓSrₓCo_{1-y}Fe_{y}O_{3±y} (wherein 0.1≦x≦0.5, 0.05≦y≦0.5, 0≦γ≦0.3), La₁₋ₓSrₓFe_{1-y}Co_{y}O_{3±y} (wherein 0.1≦x≦0.4, 0.05≦γ≦0.5, 0≦γ≦0.3), Sm₁₋ₓSrₓCoO_{3±y} (wherein 0.1≦x≦0.5, 0≦γ≦0.3), or the like. For example, an oxide such as Ba_{0.5}Sr_{0.5}Co_{0.8}Fe_{0.2}O₃, La_{0.8}Sr_{0.4}Co_{0.2}Fe_{0.8}O₃, Sm_{0.5}Sr_{0.5}CoO₃, or the like may be used.

In addition, the mixed ionic-electronic conductor may comprise a perovskite-based metal oxide represented by Formula 3 below:

BaₐSr_{b}CoₓFe_{y}Z_{1-x-y}O_{3±y} Formula 3

wherein in Formula 3, 0.4≦a≦0.6, 0.4≦b≦0.6, 0.6≦x<0.9, 0.1≦y<0.4, and Z is at least one selected from a transition metal and a lanthanide, and γ is in a range of 0≦γ≦0.3 and x+y satisfies x+y<1.

A transition metal is an element of Groups 3 to 12 of the Periodic Table of the Elements, and the transition metal according to the present specification excludes the lanthanides. Examples of the transition metal are manganese, zinc, nickel, titanium, niobium, copper, or the like, but are not limited thereto.

The lanthanides are elements of atomic numbers 57 to 70. Examples of the lanthanides include at least one selected from holmium, ytterbium, erbium, thulium, or the like, but are not limited thereto.

The perovskite-based metal oxide may include a compound of Formula 4 below:

Ba_{0.5}Sr_{0.5}CoₓFe_{y}Z_{1-x-y}O_{3±y} Formula 4

wherein in Formula 4,

Z is at least one of a transition metal or a lanthanide,

x and y are in a range of 0.75≦x≦0.85 and 0.1≦y≦0.15, respectively, and

γ is in a range of 0≦γ≦0.3 and x+y satisfies x+y<1.

For example, Z may be Ba_{0.5}Sr_{0.5}Co_{0.8}Fe_{0.1}Z_{0.1}O₃ (wherein Z=Mn, Zn, Ni, Ti, Nb, or Cu).

The perovskite-based metal oxide may be used alone or in a combination comprising at least one perovskite-based metal oxide thereof.

A resistance of the cathode may be less than about 0.35 ohms square centimeters (ohm·cm²), specifically about 0.01 ohm·cm² to about 0.35 ohm·cm², more specifically about 0.1 ohm·cm² to about 0.3 ohm·cm², when measured by complex impedance spectroscopy after a 400° C. thermal shock at 10° C. per minute. As used herein, a 400° C. thermal shock from 800° C. at 10° C. per minute means treatment by cooling from 800° C. to 400° C. at 10° C. per minute, heating at 10° C. to 800° C., and cooling at 400° C. at 10° C. per minute prior to analysis by complex impedance spectroscopy to determine the resistance of the cathode.

The cathode for a solid oxide fuel cell (SOFC) as described above may be manufactured as follows.

First, a slurry composition including a mixed ionic-electronic conductor, a resin, and an organic solvent may be formed by contacting the mixed ionic-electronic conductor, the resin, and the organic solvent; the slurry composition may be disposed, e.g., coated, on a support; and the resulting coating may be heat treated to manufacture a cathode having a structure in the form of a pattern. The cathode may be suitable for the SOFC.

The slurry composition, which is a material to form a cathode, includes a mixed ionic-electronic conductor, a resin, and an organic solvent, and the mixed ionic-electronic conductor may comprise one or more of the materials as described above in combination.

The resin and the organic solvent may be any suitable resin and any suitable organic solvent for providing a suitable slurry for coating, wherein the coating may comprise, for example, screen printing or dipping. Herein, the resin may be a temporary binder to maintain a membrane shape of the slurry prior to heat treatment and after coating of the slurry composition, and the organic solvent may provide a suitable viscosity or printing property of the slurry.

Herein, it is possible for the cathode to have a pattern by selecting an amount of the resin present after heat treatment. The amount of the resin present after the heat treatment may be about 5 to about 30 parts by weight, specifically about 5 to about 25 parts by weight, for example, about 5 to about 20 parts by weight, or about 5 to about 15 parts by weight, or about 10 to about 15 parts by weight, each of the foregoing being based on 100 parts by weight of the mixed ionic-electronic conductor. The amount of the resin within the range described above may provide a suitable cathode having a suitable pattern. The cathode may be provided by selecting a suitable amount of the resin in the slurry composition relative to the content of the mixed ionic-electronic conductor.

Examples of the resin include at least one selected from polyvinyl butyral (“PVB”), polyvinyl alcohol (“PVA”), polyvinyl pyrrolidone (“PVP”), and cellulose. In an embodiment, the resin may be a polymer obtained by polymerization of a vinyl group containing monomer, e.g., polyvinyl butyral, polyvinyl alcohol, polyvinyl acetate, polyvinylpyrrolidone, a polycarboxylate, a polycarboxylic acid such as polyacrylic acid or polymethacrylic acid, a polysulfonic acid such as polystyrenesulfonic acid, a polyester such as a polyacrylate or glycol polyacrylate, a polyamides such a polyacrylamides, a polyurethane, or a polyethylene oxide such as polypropylene oxide. The resin may be a copolymer, such as a styrene copolymer, for example a styrene-acrylic acid polymer or a styrene-ethylene oxide polymer, a copolymer of polyvinyl and maleic acid compound, for example a styrene-maleic anhydride polymer, a polyvinyl polyalkylene copolymer, for example vinyl acetate, an ethylene polymer, such as an ethylene-acrylic acid-acrylic acid ester polymer or ethylene-acrylic acid-acrylonitrile polymer, or a vinyl acetate polymer, acrylic acid-acrylonitrile polymers, or an acrylic acid-acrylamide polymer. A combination comprising at least one of the foregoing can be used.

The organic solvent suitable to select the viscosity and/or printing properties of the slurry may be contained in an amount of about 80 to about 120 parts by weight, specifically about 85 to about 110 parts by weight, based on 100 parts by weight of the mixed ionic-electronic conductor.

Examples of the solvent include an alcohol-based organic solvent or the like. For example, the solvent may be at least one selected from isopropyl alcohol, methyl ethyl ketone, ethylene glycol, and alpha-terpineol. In an embodiment, the solvent may comprise at least one solvent selected from an alcohol such as propanol (e.g., 1-propanol and 2-propanol), 1-methoxy-2-propanol, butanol (e.g., 1-butanol, 2-butanol), pentanol (e.g., 1-pentanol, 2-pentanol, and 3-pentanol), hexanol (e.g., 1-hexanol, 2-hexanol, 3-hexanol), octanol (e.g., 1-octanol, 2-octanol, and 3-octanol), tetrahydrofurfuryl alcohol, cyclopentanol, terpineol; a lactone such as butyl lactone; a cyclic ketone such as cyclopentanone, cyclohexanone, cycloheptanone, cyclooctanone, benzophenone, and cyclopropanone; a glycol such as ethylene glycol, diethylene glycol, propylene glycol, dipropylene glycol, glycol ether, glycol ether acetate; a glycerol such as glycerin; tetrahydrofuran, or a combination thereof.

The slurry composition may further include a dispersant. While not wanting to be bound by theory, it is understood that the dispersant helps the mixed ionic-electronic conductor to be uniformly distributed within the slurry composition. An amount of the dispersant may be about 2 to about 10 parts by weight, specifically about 3 to about 9 parts, based on 100 parts by weight of the mixed ionic-electronic conductor. The dispersant may comprise a commercial product, e.g., San Nopco 6067, Hypermer KD-1, fish oil, a fatty acid such as stearic acid, glyceryl trioleate, polyethylene glycol, or the like.

Examples of the support on which the slurry composition is coated may be an electrolyte layer, a response inhibition layer, or a functional layer, which will be further described later.

Then, heat treating of the resulting coating may be followed by further heat treatment at a temperature of about 800° C. to about 1,300° C., for example, about 900° C. to about 1,200° C., for about 0.1 hours to about 10 hours, or about 1 hour to about 8 hours.

The heat treating may be conducted repeatedly one or more times, for example, twice or five times. Due to the repetitive process, the thickness of the cathode may be increased.

According to another aspect, a solid oxide fuel cell (SOFC) includes the cathode; an anode; and a solid electrolyte layer disposed between the cathode and the anode.

A solid oxide electrolyte included in the electrolyte layer is desirably dense enough to prevent mixing of air and fuel, and may have high oxygen ion conductivity and low electronic conductivity. In addition, across the electrolyte, which is disposed between the cathode and the anode, is a large difference in oxygen partial pressure, and thus it is desirable to maintain the properties described above in a wide region of the oxygen partial pressure.

The solid oxide electrolyte may comprise any suitable material and is not specifically limited and may comprise a suitable material available in the art, and for example, may include at least one selected from a zirconia-, ceria-, and lanthanum gallate-based solid electrolyte. For example, the solid oxide electrolyte may include at least one selected from an undoped zirconia or a zirconia doped with at least one selected from yttrium and scandium; an undoped ceria doped or a ceria doped with at least one selected from gadolinium, samarium, lanthanum, ytterbium, and neodymium; and an undoped lanthanum gallate or a lanthanum gallate doped with at least one selected from strontium and magnesium. Examples of the solid oxide electrolyte may include stabilized zirconia such as ytteria-stabilized zirconia (“YSZ”) and scandium-stabilized zirconia (“ScSZ”); ceria including rare earth elements such as samaria doped ceria (“SDC”), gadolinia doped ceria (“GDC”); and other lanthanum strontium gallate magnesites (“LSGM”s), e.g. compounds of the formula ((La, Sr)(Ga, Mg)O₃).

A thickness of the solid oxide electrolyte may be generally in a range of about 10 nanometers (nm) to about 100 μm. For example, the thickness of the solid oxide electrolyte may be in a range of about 100 nm to about 50 μm.

The anode (fuel electrode) electrochemically oxidizes fuel and transfers electric charges to the cathode. Therefore, it is desirable that the anode catalyst has fuel oxidation catalyst properties, that it be chemically stable with the electrolyte material, and that it has a coefficient of thermal expansion which is similar to that of the electrolyte material. The anode may include a cermet that is a composite of the material forming the solid oxide electrolyte and a nickel oxide. For example, when the YSZ is used as the electrolyte, a Ni/YSZ ceramic-metallic composite may be used as the anode. In addition, a Ru/YSZ cermet or pure metal such of Ni, Co, Ru, or Pt may be used as the material for the anode, but examples of the material are not limited thereto. The anode may further include active carbon. The porosity of the anode may be selected to provide suitable fuel gas diffusion.

A thickness of the anode may be in a range of about 1 μm to about 1000 μm, and for example, the thickness of the anode may be in a range of about 5 μm to about 100 μm.

The porosity of the cathode may be selected to provide suitable oxygen gas diffusion. A reaction between the cathode and the solid oxide electrolyte 11 may be suppressed by use of a low temperature heat treatment during the manufacturing process so that generation of a non-conductive layer therebetween is also prevented or inhibited. However, a functional layer 12 may be further disposed between the cathode material layer 13 and the solid oxide electrolyte 11 if desired so as to effectively prevent a reaction therebetween. The functional layer may include at least one selected from a gadolinium doped ceria (“GDC”), samarium doped ceria (“SDC”), and yttrium doped ceria (“YDC”). A thickness of the functional layer may be in a range of about 1 μm to about 50 μm, for example in a range of about 2 μm to about 10 μm.

According to an embodiment, the SOFC may further include an electricity collecting layer including an electronic conductor on at least one side of the cathode, for example on the outside of the cathode. The electricity collecting layer may operate as a current collector for collecting electricity in the cathode.

The electricity collecting layer may include at least one selected from lanthanum cobalt oxide (e.g., LaCoO₃), lanthanum strontium cobalt oxide (“LSC”), lanthanum strontium cobalt iron oxide (“LSCF”), lanthanum strontium manganese oxide (“LSM”), and lanthanum strontium iron oxide (“LSF”). The electricity collecting layer may be formed using only one or a combination of at least one of the above listed materials. Alternatively, the electricity collecting layer may be formed in a single layer or have a stacked structure of at least two layers using the above materials.

The SOFC may be manufactured using any suitable method, e.g., a published method, the details of which can be determined without undue experimentation, and thus a detailed description thereof will be omitted here. Also, the SOFC may have any one of various structures such as a tubular type stack, a flat tubular type stack, and a planar type stack.

The SOFC may be operated at a temperature of less than about 800° C., for example in a range of about 55 0° C. to about 750° C. or in a range of about 600° C. to about 750° C. As a result, high ionic conductivity at a low temperature is maintained and thermal expansion of the cathode active material may be suppressed so that it is possible to increase the durability of the SOFC by reducing interlayer thermal maladjustment thereby improving thermal stability.

Hereinafter, provided is a cathode for the SOFC including a cathode material for the fuel cell and the SOFC including the cathode according to an embodiment, which will be described in greater detail with reference to the figures.

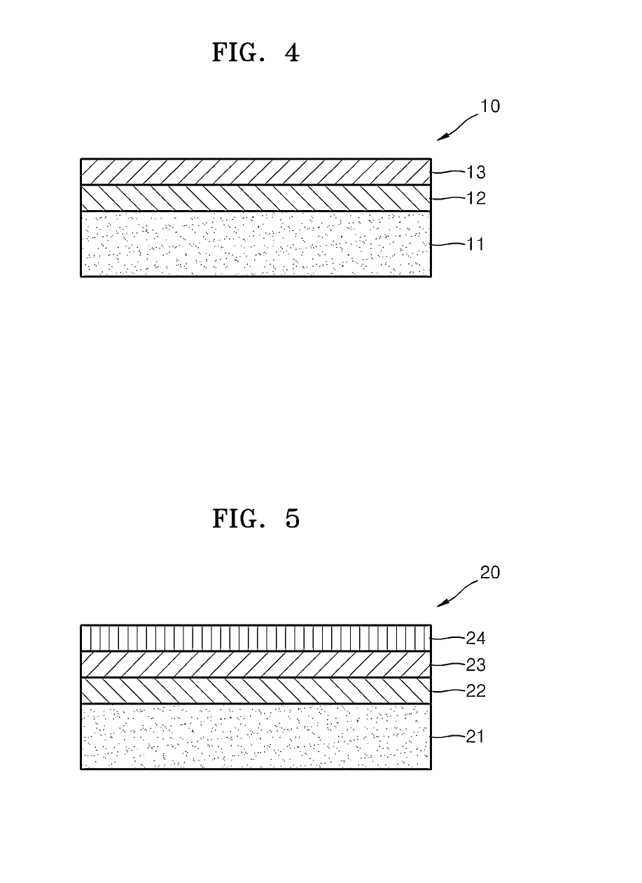

FIG. 4 is a cross-sectional view illustrating a half cell 10 including a cathode material layer 13.

The half cell 10 includes an electrolyte layer 11, a first functional layer 12, and a cathode material layer 13.

The electrolyte layer 11 may include at least one selected from scandia-stabilized zirconia (“ScSZ”), yttria-stabilized zirconia (“YSZ”), samaria doped ceria (“SDC”), and gadolinia doped ceria (“GDC”). The electrolyte layer 11 may be formed by sintering the electrolyte (e.g., ScSZ, YSZ, SDC, GDC, or a combination thereof) at a high temperature for a long time to form a dense electrolyte layer 11. Herein, the sintering may be performed by heat treatment at a temperature of about 1,450° C. to about 1,650° C. for about 6 hours to about 10 hours.

The first functional layer 12 may be effective to prevent or inhibit a reaction between the electrolyte layer 11 and the cathode material layer 13, and thus prevent or inhibit generation of a non-conductive layer (not shown) therebetween. The first functional layer 12 may include at least one selected from gadolinium doped ceria (“GDC”), samarium doped ceria (“SDC”), and yttrium doped ceria (“YDC”). The first functional layer 12 may have a compact structure suitable to provide a buffer layer. Appropriate conditions for the formation of the first functional layer 12 can be important in terms of the cathode performance. For example, in order to prevent the spread of interlayer elements and minimize interlayer separation caused by the thermal expansion, the first functional layer 12 may be formed by sintering the slurry for the first functional layer at a temperature of about 1,350° C. to about 1,450° C. for about 3 hours to about 6 hours. Herein, a thickness of the first functional layer coated on a substrate (e.g., electrolyte layer 11) may be in a range of about 15 μm to about 25 μm. The slurry used to form the first functional layer may be a combination of an oxide (e.g., at least one selected from GDC, SDC, and YDC) and an organic vehicle, such as the organic solvent as described above.

The cathode material layer 13 may include at least one selected from the compounds of Formulas 1 and 4 as described above. In an embodiment, the cathode consists of the cathode material layer 13. In another embodiment, the cathode may comprise the cathode material layer and an additional layer.

In the half cell 10 having the same configuration as described above, the SOFC (not illustrated) including the anode (not illustrated) has excellent electrochemical performance, high thermal stability, and excellent durability due to the characteristics of the materials for the SOFC included in the cathode material layer 13, such as high ionic conductivity, high electronic conductivity, and low coefficient of thermal expansion.

FIG. 5 is a cross-sectional view illustrating a half cell 20 including a cathode material layer 23 of another embodiment.

The half cell 20 includes an electrolyte layer 21, a first functional layer 22, a cathode material layer 23, and an additional layer 24. Herein, the cathode material layer 23 and the additional layer 24 together form a cathode. However, it is not limited thereto, and a cathode with various structures and a multilayer structure with a various number of layers may be included in the half cell and/or the SOFC.

A detailed configuration and function of the electrolyte layer 21, the first functional layer 22, and the cathode material layer 23 are the same as the electrolyte layer 11, the first functional layer 12, and the cathode material layer 13 as described above.

The additional layer 24 may include a lanthanide-based metal oxide having a perovskite type crystal structure. In addition, the lanthanide-based metal oxide included in the additional layer 24 may be the same compound as the second compound included in the cathode material layer 23.

The anode may include cermet, that is, a composite of a material powder of electrolyte layers 11 and 21 and nickel oxide. Also, the anode may further include active carbon.

Hereinafter, an embodiment will be described in further detail with reference to the following examples. However, these examples are not intended to limit the scope of the disclosed embodiment.

### Preparation Example 1

A composite of NiO and Zr_{0.84}Y_{0.16}O₂ (“YSZ”) was used as a material for an anode support. A bulk material was formed by die pressing the composite in a cylinder shape (diameter: 30 millimeters (mm), thickness: 1 mm).

In order to have a thickness of 20 μm on top of the anode support, Sc₂O₃-doped ZrO₂ was formed by die pressing and then sintering was performed at 1,400° C. As a result, a solid electrolyte (SE) was formed.

### Comparative Example 1

To provide a mixed ionic-electronic conductor, a slurry composition for the cathode was formed by adding 20 parts by weight of Ba_{0.5}Sr_{0.5}Co_{0.8}Fe_{0.1}Zn_{0.1}O₃ (“BSCFZ”) and 20 parts by weight of La_{0.6}Srₒ₄Coₒ₂Fe_{0.8}O₃ (“LSCF”), based on 100 parts by weight, as mixed conducting materials, and 8 parts by weight of polyvinyl butyral, based on 100 parts by weight, as a binder, into 37 parts by weight of isopropyl, which is a solvent mixture, and 16 parts by weight of methyl ethyl ketone. Herein, 2 parts by weight of the dispersant 6067 (SAN NOPCO KOREA LTD.) was next added to prepare the slurry composition for the cathode.

The slurry composition was coated on the electrolyte layer obtained from Preparation Example 1 via a dip-coating method and then thermally processed at 930° C. for about 4 hours.

### Example 1

To provide a mixed ionic-electronic conductor, 100 parts by weight of the Ba_{0.5}Sr_{0.5}Co₀₈Fe_{0.1}Zn_{0.1}O₃ (“BSCFZ”), and 100 parts by weight of the La_{0.6}Sr_{0.4}Co_{0.2}Fe_{0.8}O₃ (“LSCF”), and the binder, 24 parts by weight of the polyvinyl butyral, were mixed with the solvent mixture, 156 parts by weight of the isopropyl and 67 parts by weight of the methyl ethyl ketone. Then, 10 parts by weight of the dispersant 6067 (SAN NOPCO KOREA LTD.) was added thereto to form the slurry composition for the cathode.

The slurry composition was coated on the electrolyte layer obtained from Preparation Example 1 via a dip-coating method and then thermally processed at 930° C. for 4 hours.

### Experimental Example 1

A thermal shock test was conducted using cells obtained from the Comparative Example 1 and Example 1.

The thermal shock test was conducted under the following conditions: a temperature was raised up to about 800° C. at a heating at a rate of 10° C. per minute and maintained at 800° C. for about 30 minutes. Then, a temperature was reduced to about 400° C. by cooling at a rate of 10° C. per minute and maintained at 400° C. for about 1 hour, followed by heating up to about 800° C. by heating at a rate of 10° C. per minute and maintaining about 800° C. for about 30 minutes and then cooling down to about 400° C. at a cooling at a rate of 10° C. per minute and maintaining about 400° C. for about 1 hour.

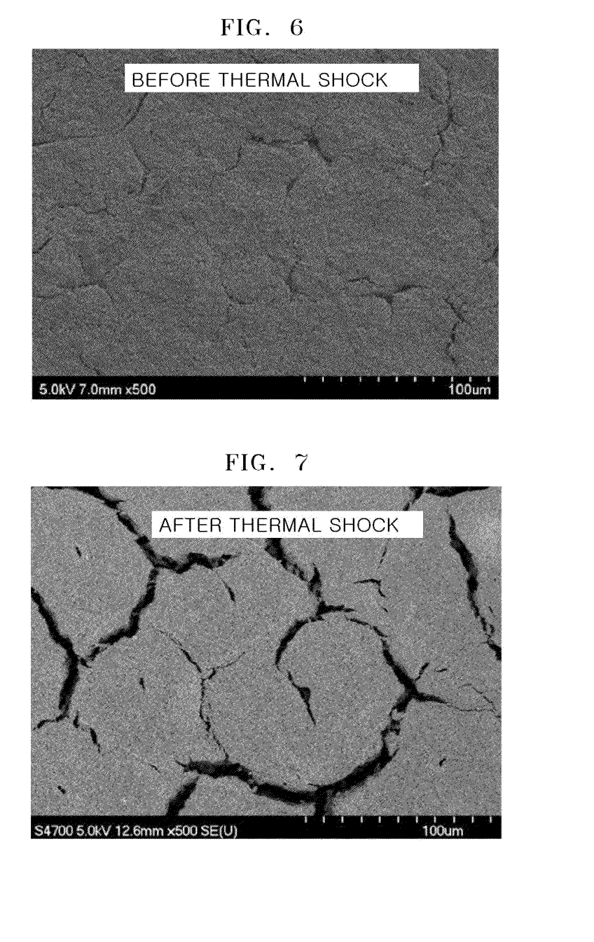

FIG. 6 is a cathode surface obtained from Comparative Example 1, which is found to have a smooth surface. FIG. 7 is an image of a cathode surface obtained from Comparative Example 1 after thermal shock occurs, and it is found to be severely cracked and damaged.

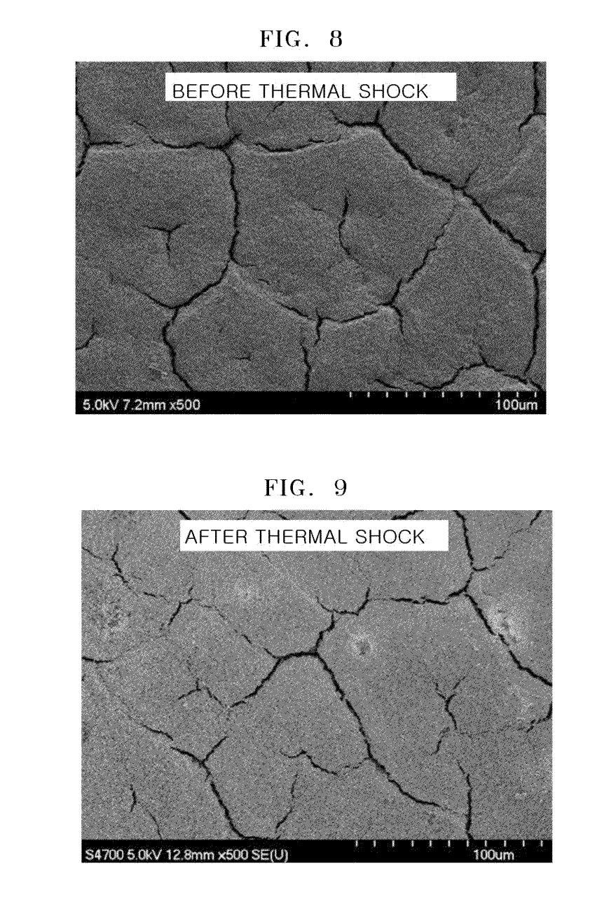

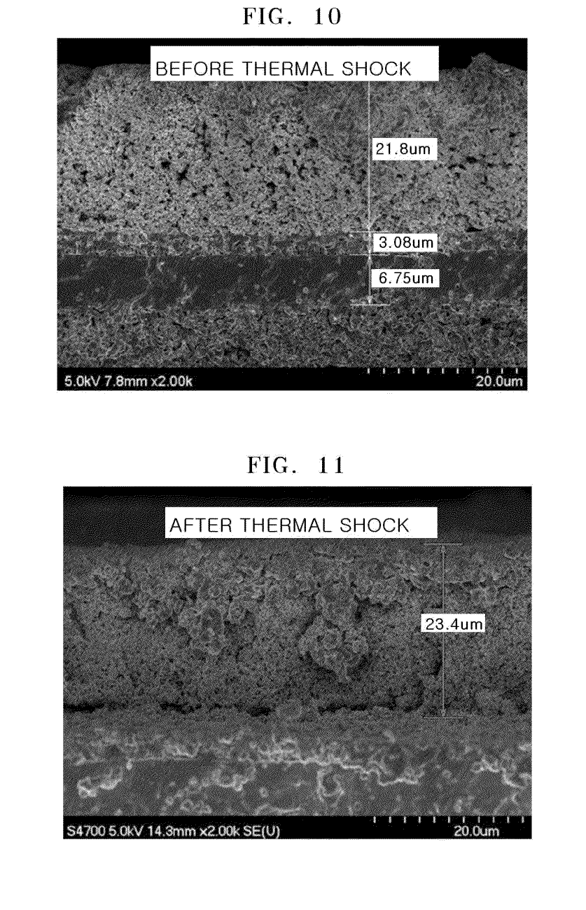

FIG. 8 is a cathode surface obtained from Example 1, and it is found to have a pattern at regular intervals. FIG. 9 is an image of a cathode obtained from Example 1 after thermal shock occurs, and it is found to maintain the shape of the cathode surface after thermal shock.

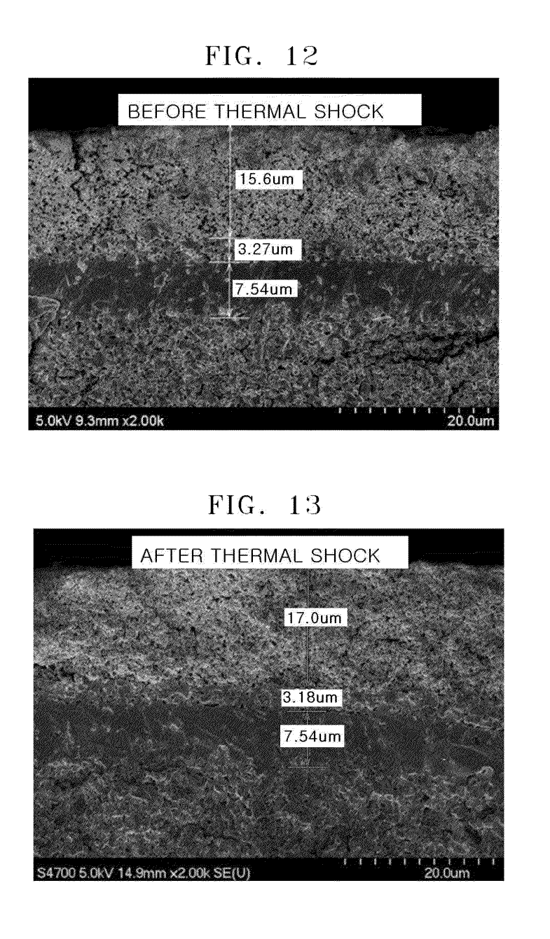

FIG. 10 is a cathode interface obtained from Comparative Example 1, and FIG. 11 is an image of a cathode interface after thermal shock. The cathode layers are found to be cracked and damaged by thermal shock.

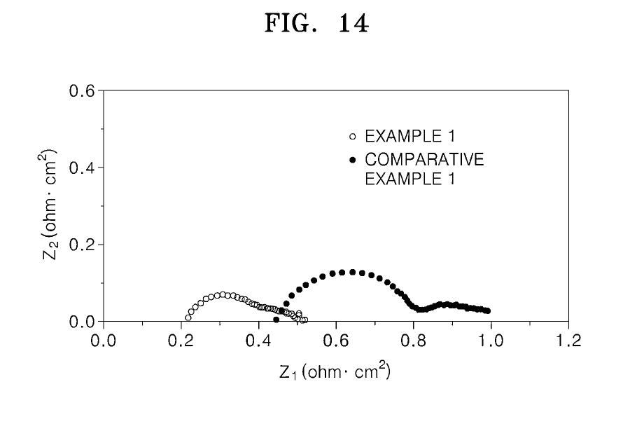

FIG. 12 is a cathode interface obtained from Example 1, and FIG. 13 is a cathode interface after thermal shock occurs, and it is found to maintain the shape of the cathode layer after the thermal shock occurs.

### Experimental Example 2

A current-voltage current power density (“I-V/I-P”) measurement (herein, I: current, V: voltage, P: power density) was performed on end cells of Example 1 and Comparative Example 1. When a cathode atmosphere was air and an anode atmosphere was hydrogen gas, an open circuit voltage (“OCV”) may be 1 volt (V) or higher. In order to obtain I-V data, a voltage-drop was measured by increasing the current from 0 Ampere to several Amperes. The voltage-drop was continuously measured until the voltage became 0 V by increasing the current. The I—P data may be calculated from the I-V data. The impedance measurement results obtained from the I-V/I-P data are illustrated in FIG. 14. In the figure, the size of the semicircle is the size of the cathode resistor (i.e., R_{ca}).

As illustrated in FIG. 14, in a comparison of resistance values after 10 cycles, the cathode resistor of Example 1 having a pattern had a significantly less resistance value compared to that of Comparative Example 1.

As described above, according to the above embodiment, a solid oxide fuel cell with excellent thermal stability may be obtained using a cathode having a structure in the form of a pattern that acts as a buffer to changes in temperature.

It should be understood that the exemplary embodiment described herein shall be considered in a descriptive sense only and not for purposes of limitation. Descriptions of features, advantages, or aspects within each embodiment should be considered as available for other similar features, advantages or aspects in other embodiments.

What is claimed is:

1. A cathode for a solid oxide fuel cell, the cathode comprising a mixed ionic-electronic conductor having a structure in a form of a pattern.

2. The cathode of claim 1, wherein a unit of the pattern is defined by a closed curve.

3. The cathode of claim 1, wherein a length of a unit of the pattern is in a range of about 10 micrometers to about 1,000 micrometers.

4. The cathode of claim 1, wherein an area of a unit of the pattern is in a range of about 10 square micrometers to about 10000 square micrometers.

5. The cathode of claim 1, wherein adjacent units of the pattern are spaced at an interval in a range of about 0.1 micrometers to about 5 micrometers.

6. The cathode of claim 1, wherein a thickness of the cathode is in a range of about 1 micrometers to about 100 micrometers.

7. The cathode of claim 1, wherein the cathode has a resistance of less than about 0.35 ohms square centimeters when determined by complex impedance spectroscopy after a 400° C. thermal shock from 800° C. at 10° C. per minute.

8. The cathode of claim 1, wherein the mixed ionic-electronic conductor comprises a perovskite metal oxide represented by Formula 1
AMO_{3±y}, Formula 1
wherein
A is at least one selected from La, Ba, Sr, Sm, Gd, and Ca,
M is at least one selected from Mn, Fe, Co, Ni, Cu, Ti, Nb, Cr, and Sc, and
γ represents a status of oxygen excess or oxygen deficiency and is in a range of 0≦γ≦0.3.

9. A method of manufacturing a cathode for a solid oxide fuel cell, the method comprising:
forming a slurry composition comprising a mixed ionic-electronic conductor, a resin, and an organic solvent;
disposing the slurry composition on a support to form a coating; and
heat treating the coating to manufacture the cathode.

10. The method of claim 9, wherein the resin comprises at least one selected from polyvinyl butyral, polyvinyl alcohol, polyvinyl pyrrolidone, and cellulose.

11. The method of claim 9, wherein the slurry composition further comprises a dispersant.

12. The method of claim 9, wherein an amount of the resin is about 5 to about 20 parts by weight, based on 100 parts by weight of the mixed ionic-electronic conductor.

13. The method of claim 9, wherein the heat treating is conducted at a temperature of about 800° C. to about 1,300° C. for about 0.1 hours to about 10 hours.

14. A solid oxide fuel cell comprising:
the cathode of claim 1;
an anode; and
a solid electrolyte disposed between the cathode and the anode.

15. A cathode for a solid oxide fuel cell, the cathode comprising:
a mixed ionic-electronic conductor,
wherein the mixed ionic-electronic conductor has a structure in a form of a pattern comprising
units comprising the mixed ionic-electronic conductor,
and an interval of about 0.1 micrometer to about 5 micrometers between adjacent units of the pattern,
wherein the cathode has a resistance of less than about 0.35 ohms square centimeters when determined by complex impedance spectroscopy after a 400° C. thermal shock from 800° C. at 10° C. per minute.

16. The cathode for a solid oxide fuel cell of claim 15, wherein a length of a unit of the pattern is in a range of about 10 micrometers to about 1,000 micrometers.

17. The cathode for a solid oxide fuel cell of claim 16, wherein an area of a unit of the pattern is in a range of about 10 square micrometers to about 10000 square micrometers.
